(19) United States
(12) Patent Application Publication
(10) Pub. No.: US 2023/0403964 A1
(43) Pub. Date: Dec. 21, 2023

(54) Method for Estimating a Course of Plant Rows

(71) Applicant: Robert Bosch GmbH, Stuttgart (DE)

(72) Inventors: Maurice Gohlke, Stuttgart (DE); Sandra Amend, Chilliwack (CA); Daniel Di Marco, Stuttgart (DE); Markus Hoeferlin, Simmozheim (DE)

(21) Appl. No.: 18/250,485

(22) PCT Filed: Nov. 20, 2020
(86) PCT No.: PCT/EP2020/082793

§ 371 Date: Apr. 25, 2023

(30) Foreign Application Priority Data
Nov. 25, 2019 (DE) 10 2019 218 177.5

(51) Int. Cl. A01B 69/00

(52) U.S. Cl. CPC A01B 69/001

(57) ABSTRACT

A method is for estimating a course of a plant row in a field while the field is being crossed in a direction of travel substantially parallel to the plant row. The method includes capturing a plurality of images of the field substantially in sync with obtaining position information relating to a position in which the individual images are captured on the field. The method also includes classifying pixels or regions in the individual images as crop plants; arranging the classified images in a global context using the obtained position information; and estimating the course of the plant row by determining a probability distribution of the pixels or regions classified as crop plants in the global context along a direction perpendicular to the direction of travel.

The present invention relates to a method for estimating a course of plant rows in a field.

The estimation of a course of plant rows for the agricultural working of a field is based predominantly on processing camera images, with one of the two methods described below usually being used.

In the first method, a segmentation first takes place, in which the vegetation is detected separately from the soil, either by distinguishing between green (plants) and brown (soil) in the visible color range, or by taking into account the NDVI Index, which is calculated by means of image information in the near-infrared range. The plant row is then estimated by means of straight-line detection between the individual plants, which were segmented beforehand as vegetation. In this case, the straight-line detection is carried out using the Hough transform.

In the second method, a segmentation of the plants first takes place. Subsequently, a center point estimation is carried out, and the plant row is estimated by means of a straight line through the plant center points. In this case, the straight-line estimation is carried out by, for example, the RANSAC algorithm, the least squares methods, etc.

It is therefore the object of the present invention to provide a method for a more robust and more accurate estimation of a plant row than is possible with the methods known hitherto in the prior art for estimating the course of plant rows. The object is achieved by the method according to claim 1. Advantageous embodiments are specified in the dependent claims.

Embodiments of the present invention will be described below with reference to the accompanying drawings, in which:

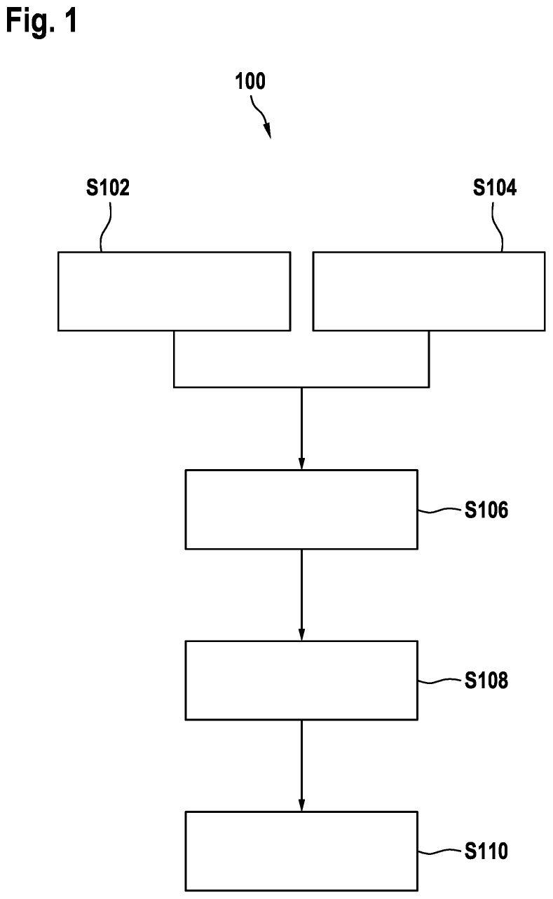

FIG. 1 is a flow chart of the method according to the invention;

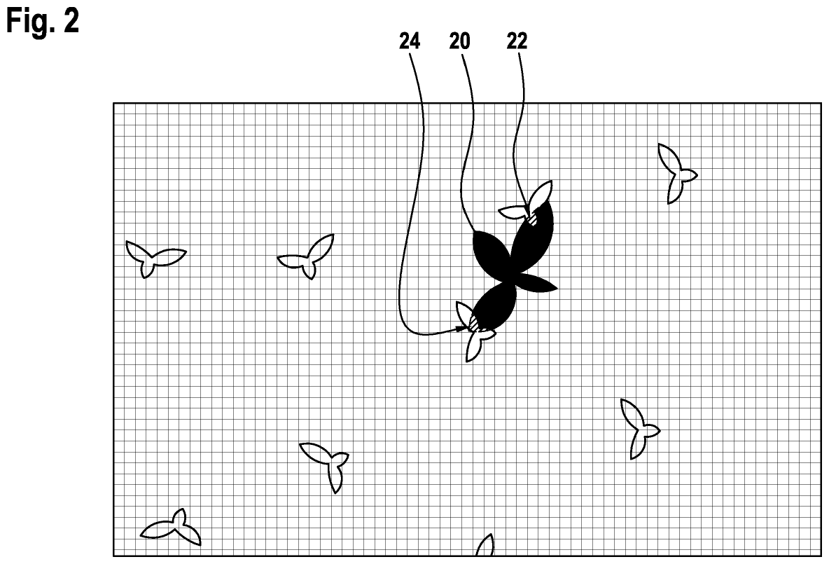

FIG. 2 is an image of a field that is semantically segmented;

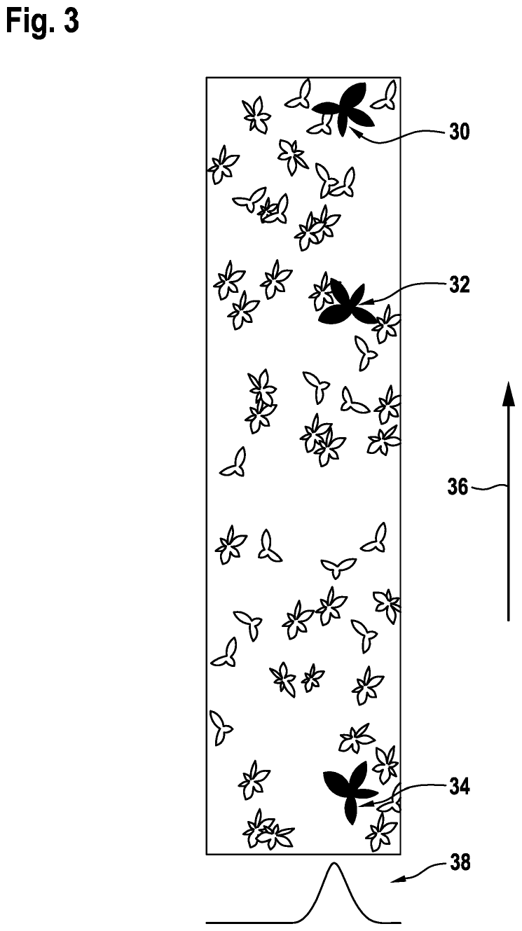

FIG. 3 is another image of a field for which a probability distribution of pixels classified as crop plants is determined.

### DETAILED DESCRIPTION OF EMBODIMENTS

In agriculture, seeds are sewn on a field, from which seeds crop plants grow. A field can be understood to mean a delimited soil area for the cultivation of crop plants, or also a part of such a field. A crop plant is understood to mean an agricultural plant which is used itself or the fruit of which is used, for example as a food, animal feed, or as an energy crop. The seeds, and consequently the plants, are primarily arranged or sewn in rows, it being possible for a predetermined distance between the individual crop plants, in which distance objects may be present, to be present between the rows and between the individual plants within a row. However, the objects are undesirable, since they reduce the yield of plants or represent a disruptive influence during the cultivation and/or harvest. An object may be understood to mean any plant that is different from the crop plant, or any article. Objects can in particular be weeds, wood and stones.

In order to reduce the aforementioned negative influence of weeds, these are either removed mechanically, for example by a rotary tiller, or sprayed with a pesticide by a sprayer. For this reason, a vehicle on which a device for working the plants is attached crosses the field along a predetermined route, i.e. in a track between two adjacent plant rows of the field, and the individual plants are worked during this time.

In this case, the vehicle is a vehicle provided specifically for working the field, such as an agricultural robot. However, the vehicle can also be an agricultural vehicle, such as a tractor, a trailer, etc., or an aircraft, such as a drone. In this case, the vehicle drives or flies over the field in a direction of travel which is substantially parallel to a row direction in which the plants are planted at the predetermined distance from one another. In this case, the vehicle crosses the field autonomously, but the field can also be crossed due to control by a user.

The individual steps S102 to S110 of the method 100 according to the invention shown in FIG. 1 are described below. It should be noted that the method 100 is carried out continuously during crossing, i.e. a continuous estimation of the plant row takes place during the crossing.

In a first method step S102, a plurality of images of a surface of the field are captured by an image capture means. The image capture means is a camera, such as a CCD camera, a CMOS camera, etc., which captures an image in the visible range and provides it as RGB values or as values in another color space. However, the image capture means can also be a camera that captures an image in the infrared range. An image in the infrared range is particularly suitable for detecting plants, since a reflection of the plants in this frequency range is significantly increased. However, the image capture means can also be, for example, a mono-, RGB, multi-spectral or hyperspectral camera. Furthermore, further data can be detected using sensors, such as 3D sensors, etc. The image capture means can also provide a depth measurement, for example by a stereo camera, a time-of-flight camera, etc. It is possible for a plurality of image capture means to be present on the vehicle, and for there to be substantially synchronous capture of a plurality of images by the different image capture means and data from different sensors.

The field on which the plants and objects are present is detected by the image capture means while the vehicle to which the image capture means is attached crosses said field. In this case, the image capture means is attached to the vehicle in such a way that an image sensor of the image capture means is substantially parallel to a surface of the field. However, the image sensor of the image capture means can also be inclined relative to the surface of the field, for example in a direction of travel of the vehicle, in order to detect a larger region of the field.

The vehicle to which the image capture means is attached drives or flies across the field, and the image capture means captures the images at a predetermined time interval. Preferably, the images are captured such that they overlap. For this reason, the image capture means captures several images per second during the crossing, as a result of which the images overlap greatly at a low crossing speed. However, it is also possible for the images to be captured such that they do not overlap. The plurality of images can also be recorded as a video. The images are subsequently stored in a memory and are subsequently available for further processing.

The subsequent step S104 is performed substantially in sync with step S102. In step S104, position information is obtained using a position detection means. While an agricultural vehicle crosses the plant rows, GNSS systems, for example RTK-GPS, are used for this purpose, which enable highly accurate localization of the vehicle on the field. The position detection means can also obtain the position information using high-precision GPS, odometry, visual odometry, encoder wheels or the use of sensors which, due to optical features, estimate the speed (e.g. cameras, speed-over-ground sensors, etc.). The position information is specified as world coordinates, but can also be specified, for example, as field coordinates, longitude and latitude, etc. The position information is then correlated with the image recorded in step S102, such that the position on the field in which the image is recorded can be exactly determined.

For this purpose, a point in the center of the image is assigned the obtained position information. However, the position information can also be assigned to another point in the image, e.g. a corner point. It should be noted that distances between the attachment position of the image capture means and the attachment position of the position detection means on the vehicle are to be taken into account when correlating the position information with the captured image. The spatial extent of the image on the field in an X- and a Y-direction can subsequently be determined using an image angle of the image capture means and the distance of the image capture means to the soil surface. If the image sensor of the image capture means is inclined relative to the surface of the field, this inclination is also to be taken into account in the calculation of the spatial extent of the image on the field. In this way, it is possible to determine the portion of the field shown by the image. Taking into account the resolution of the image, it is also possible to assign position information, and consequently a position on the field, to the pixels of the image. This procedure can also be applied to images captured by another image capture means, and to data determined by different sensors.

In step S106, the pixels in the images are classified in each case, such that it is determined which of the pixels in the image represent a crop plant. Furthermore, it is also determined which of the pixels represent a certain weed species or generally a weed, and which of the pixels represent the soil of the field. The images captured in step S102 are individually semantically segmented for this purpose, i.e. a classification of each individual pixel in the images is carried out, and the individual pixels of the images are classified as crop plant, weed species or weed, or soil. It is also conceivable to semantically segment regions composed of a plurality of pixels.

Methods and architectures for semantic segmentation of images are known from the prior art. In the present embodiment, a fully convolutional densenet is used as is disclosed in Jégou, S., Drozdzal, M., Vazquez, D., Romero, A., & Bengio, Y. (2017). “The one hundred layers tiramisu: Fully convolutional densenets for semantic segmentation”, in Proceedings of the IEEE Conference on Computer Vision and Pattern Recognition Workshops (pp. 11-19). However, a fully convolutional neural network can also be used, as is disclosed in Long, J., Shelhamer, E., & Darrell, T. (2015). “Fully convolutional networks for semantic segmentation”, in Proceedings of the IEEE conference on computer vision and pattern recognition (pp. 3431-3440). However, it is also possible to use another known method for semantic segmentation of images.

FIG. 2 shows an image of a field that is semantically segmented. In this case, each pixel in the image is assigned a class, and the pixel is colored according to the assigned class. In FIG. 2, black pixels represent the class of crop plant, and bordered but not filled regions represent a class of weed. The soil is not colored, for the purpose of simpler representation. The semantic segmentation may possibly have incorrect classifications. In the image shown in FIG. 2, pixels (dashed) in outer regions 22, 24 of the crop plant 20, in this case a sugar beet, are identified as weeds. However, since the crop plant 20, with the exception of these small regions 22, 24, is correctly identified as a crop plant, the method described below is robust with respect to these unavoidable small errors.

In the subsequent step S108, the semantically segmented images which are captured during the same crossing process and for which the position information has been obtained in S104 are arranged, using the position information, in a global context which represents a more global coordinate system compared to the pixel coordinate system on the image plane, such as a world coordinate system mentioned above. In this case, a position on the field, which is captured on the basis of the forward movement of the vehicle and the fast repetition rate during the capture of the images in different images from different perspectives, has the same position information in all images, and is thus arranged in the same place in the global context. In the context of the present invention, the expression “global context” can be understood to mean an environment with its own coordinate system, which comprises the captured field regions and in or relative to which the images can be arranged.

In step S110, the course of a plant row, i.e. consequently the coordinates of the plant row in the global context, is estimated. Starting points for this are the images, classified in a pixel-wise manner, which are arranged in the global context. FIG. 3 shows a detail from the global context, in which three crop plants 30, 32, 34 are identified and displayed in black. In addition, a plurality of weeds is identified and shown bordered. As already mentioned above, it is assumed that the movement of the vehicle takes place parallel to the plant row 36. An estimate of the plant row can thus be made by determining the parameters of a probability distribution 38 of the pixels representing the crop plant (in the case of a pixel-wise classification) or regions (in the case of a classification for larger regions or super-pixels) in the global context, as shown in FIG. 3, along a direction perpendicular to the direction of travel 36. In this case, the probability distribution 38 is preferably a symmetrical probability distribution and in particular a normal or Gaussian distribution.

A center of the plant row corresponds to a calculated expected value of the probability distribution 38, and a width of the plant row can be derived from a variance of the probability distribution 38. In this way, not only the course of the plant row, but also a width of the plant row, can be indicated. Due to the consideration of the pixels of all crop plants 30, 32, 34 in the images previously captured for the estimation of the plant row, the method according to the invention is enormously robust with respect to incorrect classification of individual pixels in the image. The method is moreover robust against inaccuracies in the row, which are frequently generated during sowing due to rolled seeds or doubly applied seeds.

Proceeding from this estimation of the plant row in the captured images, a course of the plant row in front of the vehicle can be estimated. In this case, the plant row in front of the vehicle is estimated as a continuing straight line. The estimated course of the plant row in front of the vehicle can in turn be integrated into the global context, such that the result of the pixel-wise classification of crop plants is improved during further crossing. For this purpose, a function is implemented in the region of the plant row, which function allocates a higher probability to pixels in the region of the estimated plant row in front of the field, in order to classify them as a crop plant. In this case, the function can be a trapezoidal function, a rectangular function or another suitable function. In this way, a classification of the pixels as a crop plant in the region of the estimated row can be more significantly weighted, without the existing row estimate influencing the future row estimate.

After the estimated course of the plant row in the global context is known, it is converted to a coordinate system of the vehicle. This conversion makes it possible for a working tool to be guided in a simple manner along a plant row, or the vehicle or the wheels thereof can be controlled automatically between two rows. In addition, an indication can be displayed to a driver in the event of manual crossing, when said driver controls the vehicle in the region of a plant row. Since the method according to the invention is capable of determining a width of the plant row, it is also possible to reliably prevent the plant row being crossed, even in edge regions of the plant row, such that fewer crop plants are destroyed due to an inaccurate crossing.

The method is also capable of providing further information to the user. During a crossing, a distance between two crop plants in a row is determined, such that conclusions can be drawn about a regular seed application and the emergence of the individual seeds. In addition, a conclusion about the scattering of the seeds in the width direction is possible by determining the width of individual rows, taking into account the variance of the probability distribution.

1. A method for estimating a course of a plant row in a field while the field is being crossed in a direction of travel substantially parallel to the plant row, the method comprising:
capturing a plurality of images of the field substantially in sync with obtaining position information relating to a position in which the images of the plurality of images are captured on the field;
classifying pixels or regions in the images of the plurality of images as crop plants;
arranging the classified images in a global context using the obtained position information; and
estimating the course of the plant row by determining a probability distribution of the pixels or regions classified as crop plants in the global context along a direction perpendicular to the direction of travel.

2. The method according to claim 1, wherein the pixels or regions in the images of the plurality of images are classified as crop plants, weeds, or soil by a semantic segmentation.

3. The method according to claim 1, wherein:
an expected value of the probability distribution corresponds to a center of the plant row, and
a variance of the probability distribution corresponds to a width of the plant row.

4. The method according to claim 1, wherein the probability distribution is a normal distribution.

5. The method according to claim 1, wherein the course of the estimated plant row is converted into a coordinate system of a vehicle that crosses the field.

6. The method according to claim 5, wherein a further course of the estimated plant row is estimated in front of the vehicle crossing the field, as a straight line.

7. The method according to claim 6, wherein the vehicle is automatically controlled, such that the vehicle travels in a lane between two adjacent estimated plant rows in front of the vehicle.

8. The method according to claim 6, wherein the plant row estimated in front of the vehicle is used to improve the classifying of pixels or regions in the images of the plurality of images.

9. The method according to claim 1, further comprising:
determining a distance between two crop plants in an estimated row, in order to determine a quality of a seed yield.

10. The method according to claim 1, further comprising:
using a variance of the probability distribution to determine a quality of a seed yield in the direction perpendicular to the direction of travel.

11. A computing unit for estimating a course of a plant row in a field while the field is being crossed in a direction of travel substantially parallel to the plant row, wherein the computing unit is configured to:
receive a plurality of captured images of the field substantially in sync with receiving obtained position information relating to a position in which the images of the plurality of images are captured on the field;
classify pixels or regions in the images of the plurality of images as crop plants;
arrange the classified images in a global context using the obtained position information; and
estimate the course of the plant row by determining a probability distribution of the pixels or regions classified as crop plants in the global context along a direction perpendicular to the direction of travel.

12. An agricultural work machine comprising:
a computing unit configured to estimate a course of a plant row in a field while the field is being crossed in a direction of travel substantially parallel to the plant row, the computing unit is configured to:
receive a plurality of captured images of the field substantially in sync with receiving obtained position information relating to a position in which the images of the plurality of images are captured on the field;
classify pixels or regions in the images of the plurality of images as crop plants;
arrange the classified images in a global context using the obtained position information; and
estimate the course of the plant row by determining a probability distribution of the pixels or regions classified as crop plants in the global context along a direction perpendicular to the direction of travel.
